(19) United States
(12) Patent Application Publication
(10) Pub. No.: US 2007/0180280 A1
(43) Pub. Date: Aug. 2, 2007

(54) Controlling the allocation of power to a plurality of computers whose supply of power is managed by a common power manager

(76) Inventors: Joseph E. Bolan, Cary, NC (US); Gregg K. Gibson, Apex, NC (US); Aaron E. Merkin, Holly Springs, NC (US); David B. Rhoades, Raleigh, NC (US)

Correspondence Address: IBM (RPS-BLF);c/o BIGGERS & OHANIAN, LLP, P.O. BOX 1469, AUSTIN, TX, 78767-1469, US

(21) Appl. No.: 11/344,648

(22) Filed: Feb. 1, 2006

(51) Int. Cl. G06F 1/00

(52) U.S. Cl. 713/300

(57) ABSTRACT

Methods, systems, and computer program products are disclosed for controlling the allocation of power to a plurality of computers whose supply of power is managed by a common power manager by assigning by a workload manager a power priority to each computer in dependence upon application priorities of computer software applications assigned for execution to the computer and providing, by the workload manager to the power manager, the power priorities of the computers. Controlling the allocation of power to a plurality of computers whose supply of power is managed by a common power manager may include allocating by the power manager power to the computers in dependence upon the power priorities of the computers.

### BACKGROUND OF THE INVENTION

1. Field of the Invention

The field of the invention is data processing, or, more specifically, methods, systems, and products for controlling the allocation of power to a plurality of computers whose supply of power is managed by a common power manager.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. Advances in semiconductor processing and computer architecture push the performance of the computer higher and higher. In particular, advances in computer architecture have lead to the development of powerful blade servers that offer scalable computer resources to run sophisticated computer software much more complex than just a few years ago.

In a blade server environment, some resources are shared across all server blades in the environment. Shared resources may include power, cooling, network, storage, and media peripheral resources. Reductions of these shared resources for any reason, reduces the computer resources provided by the blade server environment. In particular, reductions in power resources because of a power supply failure or any other reason forces individual server blades to operate in a degraded state or be powered off.

Priorities within the blade server environment exist to determine the order in which power is reduced to individual server blades. System administrators typically set these priorities through an interface such as an embedded command line interface (‘CLI’) to a management module in the blade server environment. Often system administrators manually set priorities for reducing power to individual server blades according to the applications executing on each server blade. A system administrator may set priorities such that power to server blades executing the most important applications is reduced last, while power to server blades executing the least important applications is reduced first. Determining the order in which power is reduced to individual server blades is a relatively simple task for system administrators when a system administrator deploys a fixed set of applications to the individual server blades. In a blade server environment where workload management software is running, however, the applications running on individual server blades is subject to change frequently. These frequent changes make manually setting priorities for reducing power to individual blades no longer a feasible option for system administrators. As a result, reducing power to server blades often occurs independent of the importance of the application running on those server blades and causes unnecessary downtime.

### SUMMARY OF THE INVENTION

Methods, systems, and computer program products are disclosed for controlling the allocation of power to a plurality of computers whose supply of power is managed by a common power manager by assigning by a workload manager a power priority to each computer in dependence upon application priorities of computer software applications assigned for execution to the computer and providing, by the workload manager to the power manager, the power priorities of the computers. Controlling the allocation of power to a plurality of computers whose supply of power is managed by a common power manager may include allocating by the power manager power to the computers in dependence upon the power priorities of the computers.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for controlling the allocation of power to a plurality of computers whose supply of power is managed by a common power manager according to embodiments of the present invention.

FIG. 2 sets forth a block diagram illustrating an exemplary system for controlling the allocation of power to a plurality of computers whose supply of power is managed by a common power manager according to embodiments of the present invention.

FIG. 3 sets forth a block diagram of automated computing machinery comprising an exemplary computer useful in controlling the allocation of power to a plurality of computers whose supply of power is managed by a common power manager according to embodiments of the present invention.

FIG. 4 sets forth a flow chart illustrating an exemplary method for controlling the allocation of power to a plurality of computers whose supply of power is managed by a common power manager according to embodiments of the present invention.

### DETAILED DESCRIPTION OF EXEMPLARY EMBODIMENTS

### Detailed Description

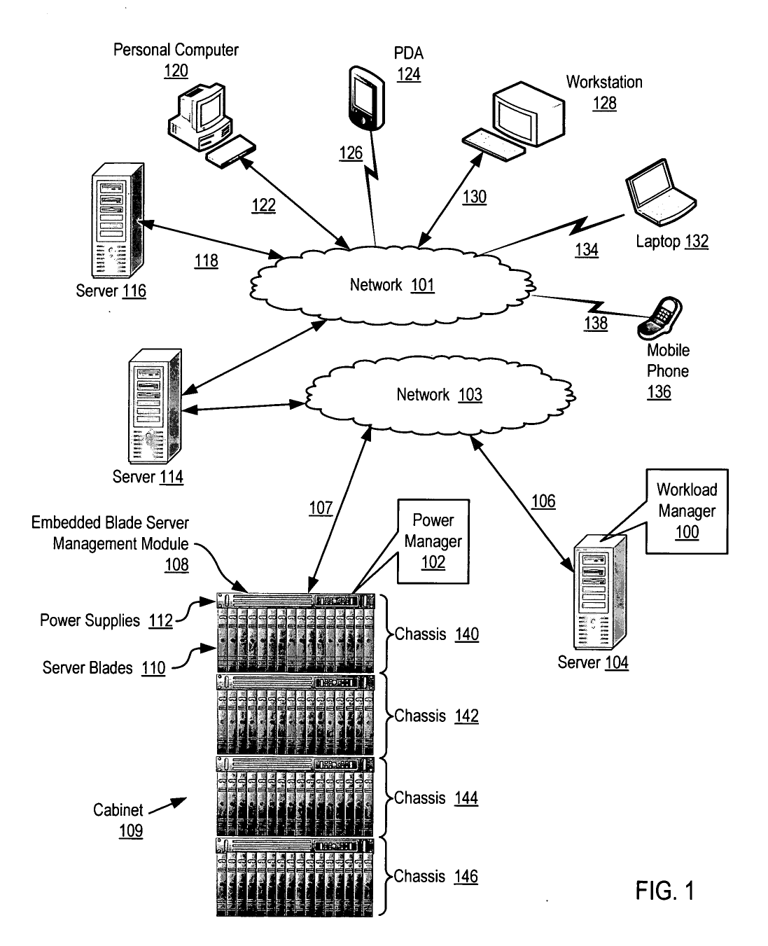

Exemplary methods, systems, and products for controlling the allocation of power to a plurality of computers whose supply of power is managed by a common power manager according to embodiments of the present invention are described with reference to the accompanying drawings, beginning with FIG. 1. FIG. 1 sets forth a network diagram illustrating an exemplary system for controlling the allocation of power to a plurality of computers whose supply of power is managed by a common power manager according to embodiments of the present invention. The system of FIG. 1 operates generally to control the allocation of power to a plurality of computers whose supply of power is managed by a common power manager (102) according to embodiments of the present invention by using a workload manager (100) to assign a power priority to each computer in dependence upon application priorities of computer software applications assigned for execution to the computer and to provide to the power manager (102) the power priorities of the computers. The system of FIG. 1 also operates generally to control the allocation of power to a plurality of computers whose supply of power is managed by a common power manager according to embodiments of the present invention by using the power manager (102) to allocate power to the computers in dependence upon the power priorities of the computers.

Power is the product of an electromotive force times a current produced by the electromotive force. A measure of electromotive force is typically expressed in units of ‘volts.’ A measure of current is typically expressed in units of ‘amperes.’ A measure of power is typically expressed in units of ‘watts.’

The system of FIG. 1 includes blade server chassis (140). Blade server chassis (140) is installed in a cabinet (109) with several other blades server chassis (142, 144, 146). Each blade server chassis is computer hardware that houses and provides common power, cooling, network, storage, and media peripheral resources to one or more server blades. Each blade server chassis in the example of FIG. 1 includes multiple power supplies (112) for providing power to server blades that includes load balancing and failover capabilities such as, for example, a hot-swappable power supply with 1400-watt or greater direct current output. The redundant power supply configuration ensures that the blade server chassis (140) will continue to provide electrical power to the server blades if one power supply fails. Examples of blade server chassis that may be improved according to embodiments of the present invention include the IBM eServer® BladeCenter™ Chassis, the Intel® Blade Server Chassis SBCE, the Dell™ PowerEdge 1855 Enclosure, and so on.

In the system of FIG. 1, each blade server chassis includes an embedded blade server management module (108) having installed upon it a power manager (102). The embedded blade server management module (108) is an embedded computer system for controlling resources provided by each blade server chassis (140) to one or more server blades. The resources controlled by the embedded blade server management module (108) may include, for example, power resources, cooling resources, network resources, storage resources, media peripheral resources, and so on. An example of an embedded blade server management module (108) that may be improved for controlling the allocation of power to a plurality of computers whose supply of power is managed by a common power manager according to embodiments of the present invention includes the IBM eServer™ BladeCenter® Management Module.

In the system of FIG. 1, a power manager (102) is computer program instructions for controlling the allocation of power to a plurality of computers according to embodiments of the present invention. In the example of FIG. 1, the computers are implemented as server blades (110) in a blade server chassis (140), and a power manager (102) manages power for all the server blades (110) in a single blade server chassis (140). A power manager (102) in the system of FIG. 1 operates generally to allocate power to computers in dependence upon the power priorities of the computers. A power priority represents the relative importance of a particular computer receiving power from power supplies (112) compared to other computers receiving power from power supplies (112).

Each blade server chassis in the system of FIG. 1 includes server blades (110) that execute computer software applications. A computer software application is computer program instructions for user-level data processing implementing threads of execution. Server blades (110) are minimally-packaged computer motherboards that include one or more computer processors, computer memory, and network interface modules. The server blades (110) are hot-swappable and connect to a backplane of a blade server chassis through a hot-plug connector. Blade server maintenance personnel insert and remove server blades (110) into slots of a blade server chassis to provide scalable computer resources in a computer network environment. Server blades (110) connect to network (103) through wireline connection (107) and a network switch installed in a blade server chassis. Examples of server blades (110) that may be useful according to embodiments of the present invention include the IBM eServer® BladeCenter™ HS20, the Intel® Server Compute Blade SBX82, the Dell™ PowerEdge 1855 Blade, and so on.

The system of FIG. 1 includes server (104) connected to network (103) through wireline connection (106). Server (104) has installed upon it a workload manager (100). The workload manager (100) is computer program instructions that manage the execution of computer software applications on a plurality of computers and controls the allocation of power to the plurality of computers whose supply of power is managed by a common power manager (102) according to embodiments of the present invention. In the system of FIG. 1, the workload manager (100) assigns computer software applications for execution on server blades (110). In the example of FIG. 1, the workload manager (100) operates generally to assign a power priority to each computer in dependence upon application priorities of computer software applications assigned for execution to the computer and to provide to the power manager (102) the power priorities of the computers. An application priority of a particular computer software application represents the relative importance associated with executing the particular application compared to executing other applications.

In the example of FIG. 1, the workload manager (100) assigns computer software applications for execution on computers in response to receiving distributed application requests for processing from other devices. Distributed application requests may include, for example, an HTTP server requesting data from a database to populate a dynamic server page or a remote application requesting an interface to access a legacy application.

The system of FIG. 1 includes a number of devices (116, 120, 124, 128, 132, 136) operating as sources for distributed application requests, each device connected for data communications in networks (101, 103). Server (116) connects to network (101) through wireline connection (118). Personal computer (120) connects to network (101) through wireline connection (122). Personal Digital Assistant (‘PDA’) (124) connects to network (101) through wireless connection (126). Workstation (128) connects to network (101) through wireline connection (130). Laptop (132) connects to network (101) through wireless connection (134). Network enabled mobile phone (136) connects to network (101) through wireless connection (138).

In the example of FIG. 1, server (114) operates as a gateway between network (101) and network (103). The network connection aspect of the architecture of FIG. 1 is only for explanation, not for limitation. In fact, systems for controlling the allocation of power to a plurality of computers whose supply of power is managed by a common power manager according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

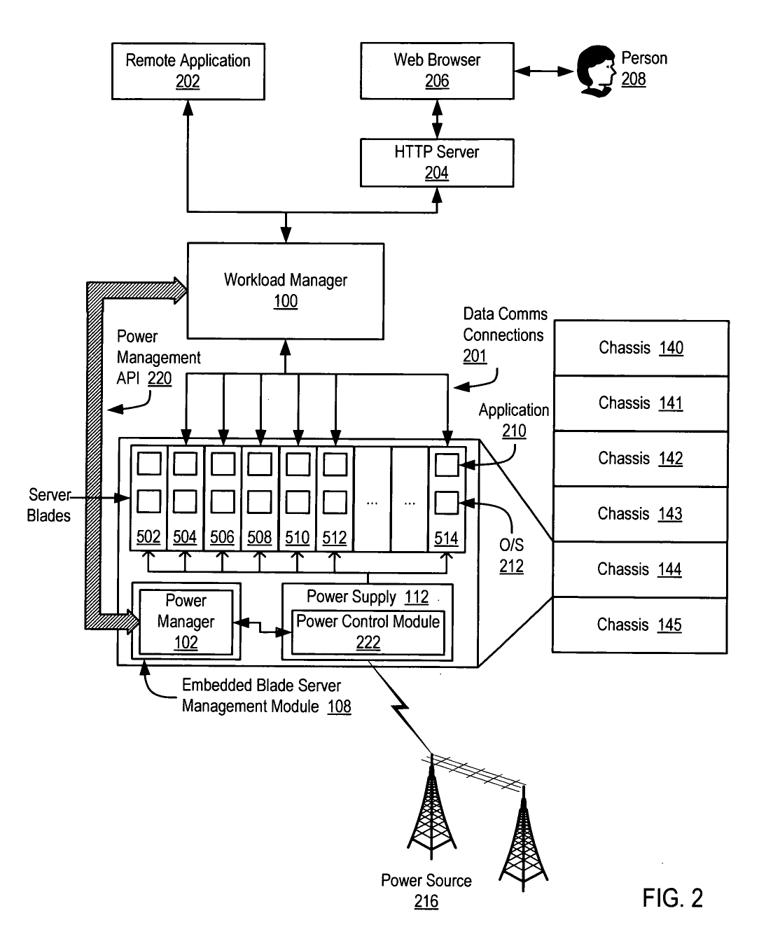

For further explanation, FIG. 2 sets forth a block diagram illustrating an exemplary system for controlling the allocation of power to a plurality of computers whose supply of power is managed by a common power manager according to embodiments of the present invention. In the example of FIG. 2, the computers are implemented as server blades (502-514). The system of FIG. 2 operates generally to control the allocation of power to a plurality of computers (502-514) whose supply of power is managed by a common power manager (102) according to embodiments of the present invention by using a workload manager (100) to assign a power priority to each computer in dependence upon application priorities of computer software applications assigned for execution to the computer and to provide to the power manager (102) the power priorities of the computers. The system of FIG. 2 also operates generally to control the allocation of power to a plurality of computers whose supply of power is managed by a common power manager according to embodiments of the present invention by using the power manager (102) to allocate power to the computers in dependence upon the power priorities of the computers.

The system of FIG. 2 includes a workload manager (100). The workload manager (100) is computer program instructions that manage the execution of computer software applications (210) on computers and controls the allocation of power to the computers according to embodiments of the present invention. In the example of FIG. 2, the workload manager (100) operates generally to assign a power priority to each computer in dependence upon application priorities of computer software applications assigned for execution to the computer and to provide to the power manager (102) the power priorities of the computers.

The system of FIG. 2 includes server blades (502-514) connected to the workload manager (100) through data communications connections (201) such as, for example, TCP/IP connections or USB connections. Each server blade (502-514) has installed upon it an operating system (212). Operating systems useful in controlling the allocation of power to a plurality of computers whose supply of power is managed by a common power manager according to embodiments of the present invention include UNIX™, Linux™, Microsoft XP™, AIX™, IBM's i5/OS™, and so on. Each server blade (502-514) also has installed upon it a computer software application (210) assigned to the server blade (502-514) by a workload manager (100).

In the example of FIG. 2, the workload manager (100) may assign applications (210) for execution on server blades (502-514) using a ‘round-robin’ algorithm. Consider, for example, a blade server chassis with eight server blades. The workload manager (100) may assign a first application for execution on the first server blade, a second application for execution on the second server blade, and so on until the workload manager (100) assigns an eighth application for execution on the eighth server blade. In the a round-robin algorithm, the workload manager (100) would continue by assigning a ninth application for execution on the first server blade, a tenth application for execution on the second server blade, and so on.

In addition to a ‘round-robin’ algorithm, the workload manager (100) may assign applications (210) for execution on server blades (502-514) according to the availability of processor or memory resources on each server blade (502-514). The workload manager (100) may therefore assign an application (210) for execution on the server blade (502-514) utilizing the least processor or memory resources. That is, the server blade (502-514) utilizing the least processor or memory resources has the most resources available to execute the application assigned for execution by the workload manager (100). The workload manager (100) may gather processor and memory resource data from each server blade (502-514) through a workload management thin client installed on each of the server blades (502-514). Although the system of FIG. 2 depicts workload manager (100) assigning computer program applications (210) for execution on server blades (502-514) installed in a single blade server chassis (144), readers will understand that such a depiction is for explanation and not limitation. In fact, workload manager (100) may assign computer program applications (210) for execution on server blades (502-514) installed in any number of blade server chassis (140-145). Examples of workload managers that may be improved for controlling the allocation of power to a plurality of computers whose supply of power is managed by a common power manager according to embodiments of the present invention includes the IBM® Enterprise Workload Manager, the Altair® PBS Pro™Workload Manager, the Moab Workload Manager™, the Hewlett-Packard Integrity Essentials Global Workload Manager, and so on.

The system of FIG. 2 also includes a power manager (102) installed on an embedded blade server management module (108). As explained above, the embedded blade server management module (108) is an embedded computer system for controlling resources provided by each blade server chassis (140-145) to one or more server blades (502-514) in the blade server chassis. In the example of FIG. 2, the power manager (102) is implemented as computer program instructions for managing the supply of power to computers. In the example of FIG. 2, the computers are implemented as server blades (502-514) in a blade server chassis (144), and the power manager (102) manages power for all the server blades (502-514) in a single blade server chassis. The power manager (102) in the system of FIG. 2 operates generally to allocate power to computers in dependence upon the power priorities of the computers.

The power manager (102) receives the power priorities from the workload manager (100). The power manager (102) receives the power priorities from the workload manager (100) through a power management application programming interface (‘API’) (220). The power management API (220) may be implemented as power management functions contained in a dynamically linked library (‘DLL’) available to the workload manager at run time. The power management API (220) may also be implemented as power management functions contained in a statically linked library included in the workload manager at compile time. Such power management functions in a power management library may include, for example:
int pm_getPowerPriority(int computerID), a function that accepts as a call parameter a computer identifier and returns a power priority currently in use for the computer in the power manager.
void pm_setPowerPriority(int computerID, int powerPriority), a function that accepts as call parameters a computer identifier and a power priority for the computer so identified and assigns the power priority to the computer (or server blade in these examples) by placing the power priority for the computer or server blade in a power priority table of the power manager.

In the example of FIG. 2, the power manager (102) connects to the workload manager (100) through a network communication connection such as, for example, a TCP/IP connection. A network connection between the power manager (102) and the workload manager (100) is for explanation only and not for limitation. In fact, the power manager (102) and the workload manager (100) may not be connected through a network connection at all because the power manager (102) and the workload (100) may be installed on the same computer. When the power manager (102) and the workload manager (100) are installed on the same computer, the workload manager (100) may provide the power priorities to power manager (102) through computer memory accessible by both the power manager (102) and the workload manager (100).

In the system of FIG. 2, each blade server chassis (140-145) includes a power supply (112) that supplies power to each of the server blades (502-514) in the blade server chassis. The power supply (112) is computer hardware that conforms power provided by a power source (216) to the power requirements of a server blade (502-514). The power source (216) is an electric power network that includes the electrical wiring of a building containing the chassis (140-145), power transmission lines, and power generators that produce power. Although FIG. 2 depicts a single power supply (112) in each blade server chassis (140-145), such a depiction is for explanation and not for limitation. In fact, more than one power supply (112) may be installed in each blade server chassis (140-145) or a single power supply (112) may supply power to server blades (502-514) contained in multiple blade server chassis (140-145).

In the system of FIG. 2, the power supply (112) includes a power control module (222) connected to the power manager (102). The power control module (222) is microcontroller that controls the quantity of power supplied to each of the blade servers (502-514) and provides power status information to the power manager (102) through a data communications connection. Power status information may include, for example, the quantity of power provided to the power supply (112) from the power source (216) as well as the quantity of power provided to each of the server blades (502-514) from the power supply (112).

The power manager (102) connects to the power control module (222) through a data communications connection implemented on a data communications bus. The data communications bus may be implemented using, for example, the Inter-Integrated Circuit (‘I²C’) Bus Protocol. The I²C Bus Protocol is a serial computer bus protocol for connecting electronic components inside a computer that was first published in 1982 by Philips. I²C is a simple, low-bandwidth, short-distance protocol. Most available I²C devices operate at speeds up to 400 Kbps, although some I²C devices are capable of operating up at speeds up to 3.4 Mbps. I²C is easy to use to link multiple devices together since it has a built-in addressing scheme. Current versions of the I²C have a 10-bit addressing mode with the capacity to connect up to 1008 nodes. Although the data communication connection between the power control module (222) and the power manager (102) may be implemented using the Inter-Integrated Circuit (‘I²C’) Bus Protocol, such an implementation is for explanation and not for limitation. Implementing the data communication bus using the I²C Bus Protocol is for explanation only, and not for limitation. The data communications bus may also be implemented using other protocols such as the Serial Peripheral Interface (‘SPI’) Bus Protocol, the Microwire Protocol, the System Management Bus (‘SMBus’) Protocol, and so on.

In the example of FIG. 2, the workload manager (100) assigns computer software applications for execution on computers in response to receiving distributed application requests for processing from client applications. Distributed application requests may include, for example, an HTTP server requesting data from a database to populate a dynamic server page or a remote application requesting an interface to access a legacy application. The workload manager (100) processes distributed application requests by executing computer software applications (210) on server blades (502-514). These computer software applications may be written in computer programming languages such as, for example, Java, C++, C#, COBOL, Delphi, and so on.

The system of FIG. 2 includes a remote application (202) that operates as a source of a distributed application request processed by workload manager (100) and server blades (502-514). The remote application (202) is computer software that executes on a network-connected computer to provide user-level data processing in a distributed computer system such as, for example, a centralized accounting system, an air-traffic control system, a ‘Just-In-Time’ manufacturing order system, and so on. The remote application (202) in the example of FIG. 2 may send distributed application requests to the workload manager (100) by calling member methods of a CORBA object or member methods of remote objects using the Java Remote Method Invocation (‘RMI’) Application Programming Interface (‘API’). The remote application (202) in the example of FIG. 2 connects to the workload manager (100) through a network communications connection using, for example, a TCP/IP connection.

‘CORBA’ refers to the Common Object Request Broker Architecture, a computer industry specifications for interopable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java Remote Method Invocation API is a Java application programming interface for performing remote procedural calls published by Sun Microsystems. The Java RMI API is an object-oriented way of making remote procedure calls between Java objects existing in separate Java Virtual Machines that typically run on separate computers. The Java RMI API uses a remote interface to describe remote objects that reside on the server. Remote interfaces are published in an RMI registry where Java clients can obtain a reference to the remote interface of a remote Java object. Using compiled ‘stubs’ for the client side and ‘skeletons’ on the server side to provide the network connection operations, the Java RMI allows a Java client to access a remote Java object just like any other local Java object.

The system of FIG. 2 includes an HTTP server (204) and a person (208) operating a web browser (206). The HTTP server (204) operates as a source of a distributed application request processed by workload manager (100) and server blades (502-514). The HTTP server (204) is computer software that uses HTTP to serve up documents and any associated files and scripts when requested by a client application. The documents or scripts may be formatted as, for example, HyperText Markup Language (‘HTML’) documents, Handheld Device Markup Language (‘HDML’) documents, eXtensible Markup Language (‘XML’), Java Server Pages (‘JSP’), Active Server Pages (‘ASP’), Common Gateway Interface (‘CGI’) scripts, and so on. The web browser (206) is computer software that provides a user interface for requesting and displaying documents hosted by HTTP server (204). In the example of FIG. 2, a person (208) may request a document from HTTP server (204) through web browser (206). To provide the requested document or script to web browser (206) for display to person (208), the HTTP server (204) may send a request for data to the workload manager (100) by calling member methods of a CORBA object or member methods of remote objects using the Java RMI API. The HTTP server (204) in the example of FIG. 2 connects to the workload manager (100) through a network communications connection such as, for example, a TCP/IP connection.

Readers will notice that in the example systems of FIGS. 1 and 2 for controlling the allocation of power to a plurality of computers whose supply of power is managed by a common power manager according to the embodiments of the present invention, the computers are implemented as server blades in a blade server chassis, and the power manager manages power for all the server blades in a blade server chassis. Readers will note, however, that the computers may also be implemented as any other kind of computers whose supply of power is managed by a common power manager. Other kinds of computer may include, for example, embedded computers, personal computers, workstations, and so on.

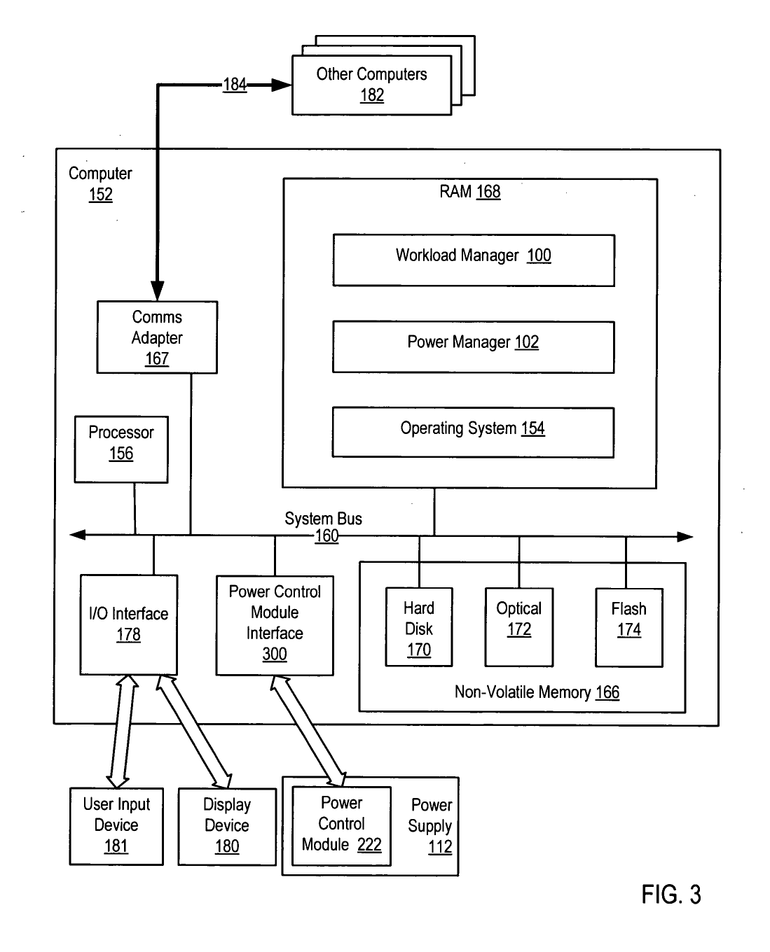

Controlling the allocation of power to a plurality of computers whose supply of power is managed by a common power manager in accordance with the present invention is generally implemented with computers, that is, with automated computing machinery. In the system of FIG. 1, for example, all the nodes, servers, communications devices, and the embedded blade server management module are implemented to some extent at least as computers. For further explanation, therefore, FIG. 3 sets forth a block diagram of automated computing machinery comprising an exemplary computer (152) useful in controlling the allocation of power to a plurality of computers whose supply of power is managed by a common power manager according to embodiments of the present invention. The computer (152) of FIG. 3 includes at least one computer processor (156) or ‘CPU’ as well as random access memory (168) (‘RAM’) which is connected through a system bus (160) to processor (156) and to other components of the computer.

Stored in RAM (168) is a workload manager (100), computer program instructions for managing the execution of computer software applications on a plurality of computers and controlling the allocation of power to a plurality of computers whose supply of power is managed by a common power manager according to embodiments of the present invention. The workload manager (100) operates generally to assign a power priority to each computer in dependence upon application priorities of computer software applications assigned for execution to the computer and to provide to the power manager (102) the power priorities of the computers. Also stored RAM (168) is a power manager (102), computer program instructions for controlling the allocation of power to a plurality of computers according to embodiments of the present invention. The power manager (102) operates generally to allocate power to computers in dependence upon the power priorities of the computers.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), workload manager (100), and power manager (102) in the example of FIG. 3 are shown in RAM (168), but many components of such software typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more power control module interface adapters (300). Power control module interface adapters (300) in computers implement input and output through, for example, software drivers and computer hardware for controlling power control modules (222) of power supplies (112).

The example computer of FIG. 3 includes one or more input and output (‘I/O’) interface adapters (178). I/O interface adapters in computers implement user-oriented input and output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182). Such data communications may be carried out serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

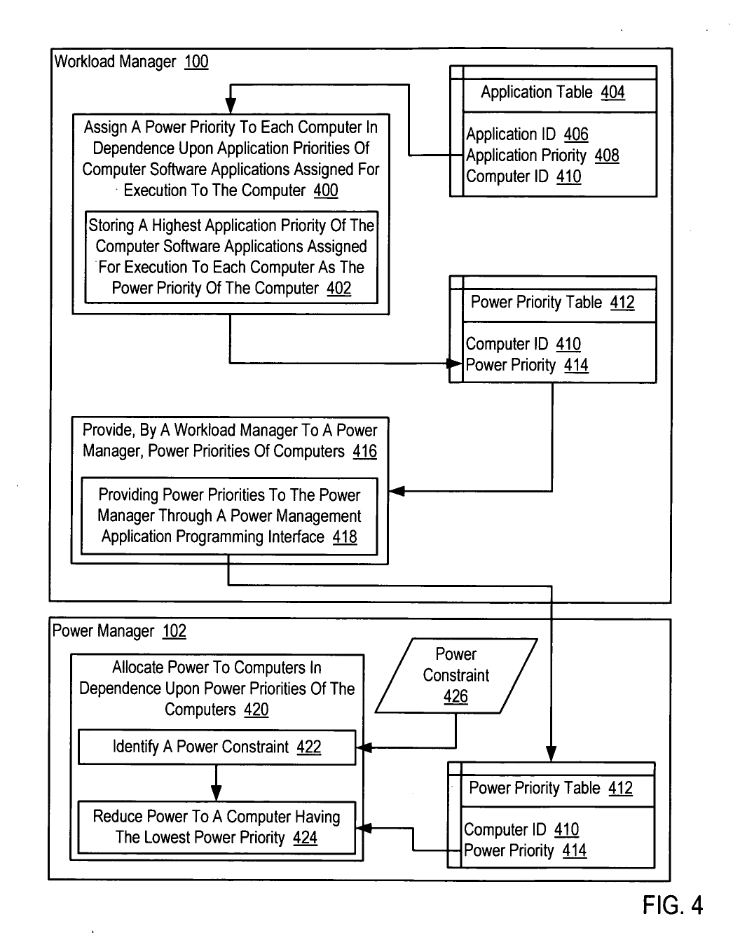

For further explanation, FIG. 4 sets forth a flow chart illustrating an exemplary method for controlling the allocation of power to a plurality of computers whose supply of power is managed by a common power manager according to embodiments of the present invention. In the method of FIG. 4, the computers are implemented as server blades in a blade server chassis, and the power manager (102) manages power for all the server blades in the blade server chassis. The method of FIG. 4 includes assigning (400) by a workload manager (100) a power priority (414) to each computer in dependence upon application priorities (408) of computer software applications assigned for execution to the computer. In the example of FIG. 4, the workload manager (100) obtains the application priority (408) from an application table (404).

In the example of FIG. 4, the application table (404) associates an application identifier (406), an application priority (408), and a computer identifier (410). The application priority (408) of a particular computer software application represents the relative importance associated with executing the particular application compared to executing other applications. Low values for the application priority (408) of an application represent high importance associated with executing that particular application. For example, executing an application with a value of ‘1’ for the application priority is more important that executing an application with a value of ‘2’ for the application priority, executing an application with a value of ‘2’ for the application priority is more important that executing an application with a value of ‘3’ for the application priority, and so on. System administrators typically pre-configure the application priority (408) of each application in the application table (404). The computer identifier (410) represents the particular computer on which a workload manager (100) assigns the associated application for execution.

In the method of FIG. 4, assigning (400) by the workload manager (100) a power priority (414) to each computer includes storing (402) a highest application priority of the computer software applications assigned for execution to each computer as the power priority (414) of the computer. The workload manager (100) may obtain the highest application priority of the computer software applications assigned for execution to each computer by scanning the application priority (408) in the application table (404) for the highest value associated with a particular value for the computer identifier (410) representing the computer on which the applications are assigned for execution. In the method of FIG. 4, the workload manager (100) assigns (400) a power priority (414) to each computer by storing the application priority (414) in a power priority table (412).

The example of FIG. 4 includes a power priority table (412) that associates a computer identifier (410) and a power priority (414). A power priority (414) represents the relative level of importance of a particular computer receiving power compared to other computers receiving power. In this example, low values for the power priority (414) of a computer represent high importance associated with that computer receiving power. For example, providing power to a computer with a value of ‘1’ for the power priority (414) is more important that providing power to a computer with a value of ‘2’ for the power priority (414), providing power to a computer with a value of ‘2’ for the power priority (414) is more important that providing power to a computer with a value of ‘3’ for the power priority (414), and so on.

In the method of FIG. 4, storing (402) a highest application priority of the computer software applications assigned for execution to each computer as the power priority (414) of the computer requires that the range of values for application priority (408) matches the range of values for the power priority (414). That is, a one-to-one mapping exists between values for the application priority (408) and values for the power priority (414). For example, if the highest application priority of the computer software applications assigned for execution to a computer is ‘1,’ then the power priority assigned to the computer is ‘1,’ if the highest application priority of the computer software applications assigned for execution to a computer is ‘2,’ then the power priority assigned to the computer is ‘2,’ and so on. There is, however, no requirement in the present invention that the range of values for application priority (408) matches the range of values for the power priority (414) map in any particular way to the power priorities of the power manager. In fact, a one-to-one mapping may not exist between values for the application priority (408) and values for the power priority (414) because the workload manager (100) and the power manager (102) may allocate different quantities of memory for storing the application priority (408) and the power priority (414). For example, the range of possible values for the application priority (408) may include ‘1’ to ‘100’, while the range of possible values for the power priority (414) may only include ‘1’ to ‘10.’

When a one-to-one mapping may not exist between values for the application priority (408) and values for the power priority (414), a workload manager (100) may assign (400) a power priority (414) to each computer in dependence upon the application priorities (408) by proportionally mapping more than one applications priority (408) to a single power priority (414). Consider again the example from above where the range of possible values for the application priority (408) includes ‘1’ to ‘100’, while the range of possible values for the power priority (414) only includes ‘1’ to ‘10.’ The workload manager (100) may map values ‘1’ to ‘10’ for the application priority (408) to a value of ‘1’ for the power priority (414), map values ‘11’ to ‘20’ for the application priority (408) to a value of ‘2’ for the power priority (414), map values ‘21’ to ‘30’ for the application priority (408) to a value of ‘3’ for the power priority (414), and so on.

Although an application priority (408) represents the relative importance associated with executing a particular application compared to executing other applications, some workload managers may place higher priority on the combined execution of several applications having lower application priorities (408) than the execution of a single application having a higher application priority (408). A workload manager (100) may therefore assign (400) a power priority (414) to each computer in dependence upon the application priorities (408) by calculating the power priority (414) as the sum of weighted application priorities (408). A workload manager (100) may weight the application priorities (408) as the inverse of the application priority (408). Consider, for example, a workload manager (100) assigning for execution on a first computer a single application having a value of ‘1’ for the application priority (408) and the workload manager (100) assigning for execution on a second computer a three applications having a value of ‘2’ for the application priority (408). A workload manager (100) calculating the power priority (414) as the sum of weighted application priorities (408) for the first computer results in a value of ‘1’ for the power priority (414) of the first computer. That is, the inverse of ‘1’ is ‘1.’ A workload manager (100) calculating the power priority (414) as the sum of weighted application priorities (408) for the second computer results in a value of ‘1.5’ for the power priority (414) of the second computer. That is, the sum of the inverse of ‘2’, the inverse of ‘2’, and the inverse of ‘2’ is the sum of ‘0.5’, ‘0.5’, and ‘0.5’, or ‘1.5.’ In this example, high values for the power priority (414) of a computer represent high importance associated with that computer receiving power than other computers. That is, the second computer has a higher importance of receiving power than the first computer.

The method of FIG. 4 also includes providing (416), by the workload manager (100) to the power manager (102), the power priorities (414) of the computers. In the method of FIG. 4, providing (416) to the power manager the power priorities (414) of the computers includes providing (418) the power priorities (414) to the power manager (102) through a power management application programming interface. The power management API (220) may be implemented as power management functions contained in a dynamically linked library (‘DLL’) available to the workload manager at run time. The power management API may also be implemented as power management functions contained in a statically linked library included in the workload manager at compile time. An example of a power management function in a power management library may include:
void pm_setPowerPriority(int computerID, int powerPriority), a function that stores the value of powerPriority in the power priority (414) associated with a value of computerID for the computer identifier (410) in the power priority table (412) in the power manager (102).

Although readers will notice that the method of FIG. 4 includes only one power manager (102), the workload manager (100) of FIG. 4 may assign applications for execution on computers whose power supply is managed by more than one power manager (102). When the workload manager (100) assigns applications for execution on computers whose power supply is managed by more than one power manager (102), power priority table (412) on the workload manager (100) may also associate a power manager identifier with the computer identifier (410) and the power priority (414). A power manager identifier represents the power manager controlling the allocation of power to the computer represented by the computer identifier (410). An example of a power management function in a power management library when the workload manager (100) assigns applications for execution on computers whose power supply is managed by more than one power manager (102) may include:
void pm_powerPriorityUpdate(int powerManagerID, int computerID, int powerPriority), a function that stores the value of powerPriority in the power priority (414) associated with a value of computerID for the computer identifier (410) in the power priority table (412) in the power manager (102) represented by the value of powerManagerID.

When the workload manager (100) and the power manager (102) are installed on separate computers, the power management functions in a power management API, as discussed above, may implement the actual data communications between the workload manager (100) and the power manager (102). The power management API may create a data communications connection such as, for example, a TCP/IP connection. In TCP parlance, the endpoint of a data communications connection is a data structure called a ‘socket.’ Two sockets form a data communications connection, and each socket includes a port number and a network address for the respective data connection endpoint. Using TCP/IP, the power management API used by the workload manager (100) may send the power priorities (414) of the computers to power manager (102) through the two TCP sockets. Implementing the data communications connection with a TCP/IP connection, however, is for explanation and not for limitation. The power management API may provide the power priorities (414) of the computers to the power manager (102) through data communications connections using other protocols such as, for example, the Internet Packet Exchange (‘IPX’) and Sequenced Packet Exchange (‘SPX’) network protocols.

Although readers will notice that providing the power priorities (414) of the computers through a data communications connection is required when the workload manager (100) and the power manager (102) are installed on separate network-connected computers, the workload manager (100) and the power manager (102) may be installed on the same computer. When the workload manager (100) and the power manager (102) are installed on the same computer, the power management API may also provide (418) power priorities (414) of computers to a power manager (102) by storing the power priorities (414) of computers in computer memory directly accessible by both the workload manager (100) and the power manager (102).

The method of FIG. 4 also includes allocating (420) by the power manager (102) power to the computers in dependence upon the power priorities (414) of the computers. Allocating (420) by the power manager (102) power to the computers in dependence upon the power priorities (414) of the computers according to the method of FIG. 4 includes identifying (422) a power constraint (426). A power constraint (426) represents a reduction in power supplied by a power supply to computers. A power manager (102) may identify (422) a power constraint by receiving alert data from a power control module in a power supply through a data communications connection such as, for example, the Inter-Integrated Circuit (‘I²C’) Bus Protocol, the Serial Peripheral Interface (‘SPI’) Bus Protocol, the Microwire Protocol, and so on. As explained above, the power control module is microcontroller that controls the quantity of power supplied to each of the computers and provides power status information to the power manager (102) through a data communications connection.

In the method of FIG. 4, allocating (420) by the power manager (102) power to the computers in dependence upon the power priorities (414) of the computers also includes reducing (424) power to a computer having a lowest power priority in response to identifying the power constraint (426). The power manager (102) may reduce (424) power by identifying the computer having the lowest power priority from the power priority table (412) in the power manager (102) and instructing a power control module to reduce power to the identified computer. The power manager (102) may instruct the power control module to reduce power to the identified computer by sending control data to the power control module through a data communications connection.

Exemplary embodiments of the present invention are described largely in the context of a fully functional computer system for controlling the allocation of power to a plurality of computers whose supply of power is managed by a common power manager. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for controlling the allocation of power to a plurality of computers whose supply of power is managed by a common power manager, the method comprising:
assigning by a workload manager a power priority to each computer in dependence upon application priorities of computer software applications assigned for execution to the computer; and
providing, by the workload manager to the power manager, the power priorities of the computers.

2. The method of claim 1 further comprising allocating by the power manager power to the computers in dependence upon the power priorities of the computers.

3. The method of claim 1 further comprising allocating by the power manager power to the computers in dependence upon the power priorities of the computers, such allocating further comprising:
identifying a power constraint; and
responsive to identifying the power constraint, reducing power to a computer having a lowest power priority.

4. The method of claim 1 wherein providing, by the workload manager to the power manager, the power priorities of the computers further comprises providing the power priorities to the power manager through a power management application programming interface.

5. The method of claim 1 wherein assigning by the workload manager the power priority to each computer further comprises storing a highest application priority of the computer software applications assigned for execution to each computer as the power priority of the computer.

6. The method of claim 1 wherein the computers are server blades in a blade server chassis, and the power manager manages power for all the server blades in the blade server chassis.

7. A system for controlling the allocation of power to a plurality of computers whose supply of power is managed by a common power manager, the system comprising:
a computer processor;
a computer memory operatively coupled to the computer processor, the computer memory having disposed within it computer program instructions capable of:
receiving, by the power manager from a workload manager, power priorities of the computers; and
allocating by the power manager power to the computers in dependence upon the power priorities of the computers.

8. The system of claim 7 further comprising computer program instructions capable of assigning by the workload manager a power priority to each computer in dependence upon application priorities of computer software applications assigned for execution to each computer.

9. The system of claim 7 wherein allocating by the power manager power to the computers in dependence upon the power priorities of the computers further comprises:
identifying a power constraint; and
responsive to identifying a power constraint, reducing power to a computer having a lowest power priority.

10. The system of claim 7 wherein receiving, by the power manager from a workload manager, power priorities of the computers further comprises receiving the power priorities from the workload manager through a power management application programming interface.

11. The system of claim 7 further comprising computer program instructions capable of assigning by the workload manager a power priority to each computer in dependence upon application priorities of computer software applications assigned for execution to each computer, such assigning further comprising storing a highest application priority of the computer software applications assigned for execution to the computer as the power priority of the computer.

12. The system of claim 7 wherein the computers are server blades in a blade server chassis, and the power manager manages power for all the server blades in the blade server chassis.

13. A computer program product for controlling the allocation of power to a plurality of computers whose supply of power is managed by a common power manager, the computer program product disposed upon a signal bearing medium, the computer program product comprising computer program instructions capable of:
assigning by a workload manager a power priority to each computer in dependence upon application priorities of computer software applications assigned for execution to the computer; and
providing, by the workload manager to the power manager, the power priorities of the computers.

14. The computer program product of claim 13 wherein the signal bearing medium comprises a recordable medium.

15. The computer program product of claim 13 wherein the signal bearing medium comprises a transmission medium.

16. The computer program product of claim 13 further comprising computer program instructions capable of allocating by the power manager power to the computers in dependence upon the power priorities of the computers.

17. The computer program product of claim 13 further comprising computer program instructions capable of allocating by the power manager power to the computers in dependence upon the power priorities of the computers, such allocating further comprising:
identifying a power constraint; and
responsive to identifying the power constraint, reducing power to a computer having a lowest power priority.

18. The computer program product of claim 13 wherein providing, by the workload manager to the power manager, the power priorities of the computers further comprises providing the power priorities to the power manager through a power management application programming interface.

19. The computer program product of claim 13 wherein assigning by the workload manager the power priority to each computer further comprises storing a highest application priority of the computer software applications assigned for execution to each computer as the power priority of the computer.

20. The computer program product of claim 13 wherein the computers are server blades in a blade server chassis, and the power manager manages power for all the server blades in the blade server chassis.
